(19) United States
(12) Patent Application Publication
(10) Pub. No.: US 2014/0302207 A1
(43) Pub. Date: Oct. 9, 2014

(54) FRUIT BREAKING SYSTEM AND METHOD

(71) Applicant: Meduri Farms, Inc., Dallas, OR (US)

(72) Inventors: Joseph J. MEDURI, Dallas, OR (US); Homer Paul GROB, JR., Sherwood, OR (US)

(73) Assignee: Meduri Farms, Inc., Dallas, OR (US)

(21) Appl. No.: 13/856,331

(22) Filed: Apr. 3, 2013

(51) Int. Cl. A23L 1/212

(52) U.S. Cl. CPC A23L 1/212
USPC 426/281; 426/444

(57) ABSTRACT

Methods as described in the present disclosure generally include cryogenically freezing sweetened, dried fruit having a moisture content between 8% and 18%, and then breaking the frozen fruit into pieces having an appropriate size distribution. Cryogenically freezing the fruit may be accomplished by passing the fruit through a cold gas tunnel or by immersing or otherwise exposing the fruit to a cryogenic substance such as liquid nitrogen, liquid oxygen, solid carbon dioxide, gaseous nitrogen, or a mixture of liquid nitrogen and gaseous nitrogen. Breaking the fruit may be accomplished, for example, by rapidly vibrating the frozen fruit on a screen, or by passing the frozen fruit through a mechanical breaking device such as a multi-stage roller mill having cryogenically cooled rollers. A system for producing pieces of sweetened, dried fruit may include apparatus for drying the fruit, infusing it with sugar or otherwise sweetening it, immersing or otherwise exposing the fruit to a cryogenic substance, and/or breaking the frozen fruit through vibration, millling, or the like.

### INTRODUCTION

Dried fruit pieces have a wide range of industrial food uses, such as in cereals, in trail mixes, in cookies, as flavorings, or as self-contained fruit snacks. In some applications, the fruit may be unsweetened, but in other applications, it is desirable that the fruit pieces be sweetened by infusing them with sugar or another sweetener, such as corn syrup or the like. In either case, whole dried fruit often is too large to be suitable for many commercial purposes, and the fruit therefore must be formed into relatively small pieces in some manner.

Forming fruit, particularly dried fruit, into pieces on an industrial scale may be difficult due to the sticky nature of the fruit. The stickiness of the fruit both causes the pieces to clump together, and also inhibits cutting or breaking the fruit, since any machinery used may become “gummed up” with the sticky fruit pieces. This difficulty may depend on factors such as the sugar content of the fruit, the moisture content of the fruit, and the temperature at which the fruit is cut or otherwise broken. Although the sugar content of the fruit generally is based on the desired end use of the fruit, and is determined prior to forming the fruit into pieces, the moisture content and temperature of the fruit during cutting or breaking may be adjustable.

The most suitable long-term moisture content of dried fruit may depend upon factors such as whether or not the fruit contains preservatives, and whether or not the fruit is sweetened. For example, unsweetened, unpreserved fruit may be stored with a moisture content between 22%-25%, which typically is sufficiently low to inhibit the growth of yeast, mold, and other undesirable substances. On the other hand, it may be desirable to dry sugar-infused or otherwise sweetened fruit to a lower moisture content, such as between 8%-18%, since the presence of more sugars generally is more conducive to undesirable growths. Furthermore, a lower moisture content may make dried fruit more brittle and/or less sticky, which may be advantageous for some methods of breaking or cutting the fruit.

Various methods have been developed for overcoming the inherent stickiness of dried fruit and successfully forming it into small pieces. One such method includes coating the fruit with a nonstick agent, such as oil or cornstarch, either before or after cutting the fruit. While this generally is an effective way of preventing clumping of fruit pieces after they are formed, it does little to affect the stickiness of the interior of the fruit, which is primarily what makes large-scale cutting or breaking difficult. Another method is to grind dried fruit into a paste, and then to form the paste into small pieces, with or without a nonstick coating. However, the fruit pieces formed by this method tend to absorb moisture, which may lead to undesirable growth of yeast or mold as previously described. Such fruit pieces also may suffer from a loss of integrity (i.e., they may fall apart), and they may be aesthetically less appealing than fruit pieces formed by other methods.

Methods of processing fruit that include freezing the fruit also have been developed. Factors such as the moisture content of the fruit, the sugar content of the fruit, and the intended use of the fruit may influence which of these methods is most suitable. For example, sweetened jams and jellies may be manufactured by freezing whole, dried or undried fruit, pulverizing the frozen fruit, and then defrosting and/or drying the pulverized fruit with the addition of a sweetener. However, sweetened pulverized fruit generally is not appropriate for cereals and other similar dried fruit applications. A method of cryogenically freezing and then shattering dried fruit is disclosed in U.S. Pat. No. 6,183,795, issued Feb. 6, 2001. However, the disclosed method is limited to unsweetened fruit having a moisture content of at least 22%, and therefore is unsuitable for use with sugar-infused or otherwise sweetened fruit.

Additional methods and apparatus for producing pieces of sweetened, dried fruit are disclosed in U.S. Patent Application Publication No. 2008/0166468 to Meduri, which is hereby incorporated by reference for all purposes. However, the methods previously disclosed by Meduri result in a significant degree of sticking or “gumming” of the breaking apparatus, requiring undesirable down time of the apparatus for cleaning, and making it difficult or impossible to produce fine granules or particles of fruit suitable for use as flavorings in the food industry.

### SUMMARY

The present teachings provide a method and apparatus for producing pieces of sweetened, dried fruit, which generally improve upon the methods previously disclosed in U.S. Patent Application Publication No. 2008/0166468. Methods as described in the present disclosure generally include freezing sweetened, dried fruit having a moisture content between 8% -18%, and then breaking the frozen (or cryogenically frozen) fruit into pieces having an appropriate size distribution. The present teachings disclose improvements that result in significant better performance of the breaking apparatus and that allow sweetened, dried fruit to be broken into smaller particles or granules which are, for example, suitable for use as flavorings in the food industry.

According to the present teachings, fruit can be frozen in a number of ways. For example, it can be immersed in a bath of liquid nitrogen, as described for example in U.S. Patent Application Publication No. 2008/0166468. Alternatively, the fruit can be transported through a cold gas tunnel, as described for example, in U.S. Patent Application Publication No. 2011/0185761, which is hereby incorporated by reference for all purposes. An example of a suitable cold gas tunnel is a FRESHLINE MP model 1220.6 produced by AIR PRODUCTS.

Breaking the fruit may be accomplished, for example, by rapidly vibrating the frozen fruit on a screen, or by passing the frozen fruit through a mechanical breaking device, such as a roller mill. Previously, roller mills were thought to be unsuitable or at least undesirable for mechanically breaking frozen fruit. However, the present applicants have discovered that cryogenically cooling two or more rollers of a roller mill may allow the roller mill to be utilized for such applications.

In some embodiments, the method also may include drying the fruit prior to breaking it into pieces, infusing the fruit with sugar before supercooling it, drying the fruit after breaking it into pieces, and/or infusing, drying, and supercooling the fruit in any order.

A system for producing the pieces of sweetened, dried fruit according to aspects of the present teachings may include apparatus for drying the fruit, infusing it with sugar or otherwise sweetening it, immersing or otherwise exposing the fruit to a supercooled substance, and/or breaking the fruit through vibration, grinding, milling, cutting, or the like. Some or all of the parts of a device that performs the vibration, grinding, milling, cutting, and/or the like, may be cryogenically cooled in order to counteract the heat produced from the breaking of the fruit by the device and/or to prevent any latent heat from those parts from partially thawing or otherwise undesirably increasing the temperature of the frozen fruit.

### BRIEF DESCRIPTION OF THE DRAWINGS

FIG. 1 is a schematic block diagram showing a system for breaking fruit according to aspects of the present disclosure.

FIG. 2 is a perspective view of a portion of a fruit breaking system including a roller mill, according to aspects of the present disclosure.

FIG. 3 is a semi-schematic sectional view of the roller mill of FIG. 2 taken along the line 2-2, normal to the arrows of line 2-2.

FIG. 4 is a schematic diagram showing a side view of rollers and cooling manifolds in the roller mill of FIGS. 2 and 3.

FIG. 5 is a detailed isometric view of teeth disposed along ridges of an illustrative roller.

FIG. 6 is a schematic plan view of an illustrative drive mechanism and a roller separation mechanism for a pair of rollers.

FIG. 7 is a flow chart depicting an illustrative method of mechanically sizing fruit.

FIG. 8 is a flow chart depicting an illustrative method for transforming whole fruit into dried fruit pieces.

FIG. 9 is a flow chart depicting an illustrative method for transforming fruit into dried sweetened fruit pieces.

### DETAILED DESCRIPTION

The present disclosure provides methods and apparatus for mechanically sizing sweetened, dried fruit by freezing and then breaking the fruit. In some embodiments, the fruit may be sweetened by infusing it with sugar, for example in a sugar bath, whereas in other embodiments the fruit may be pre-sweetened prior to application of the presently disclosed methods and apparatus. The sweetened and/or dried fruit may have a moisture content of 8%-18% or may be dried to a moisture content within that range, and then frozen by exposure to a cryogen such as liquid nitrogen, liquid oxygen, liquid helium, liquid carbon dioxide, solid carbon dioxide (dry ice), gaseous nitrogen, or a mixture of liquid nitrogen and gaseous nitrogen forming a nitrogen vapor, among others. The frozen fruit then may then be mechanically broken by any suitable means, such as vibration, grinding, centrifugal breaking, 2-stage breaking, or milling.

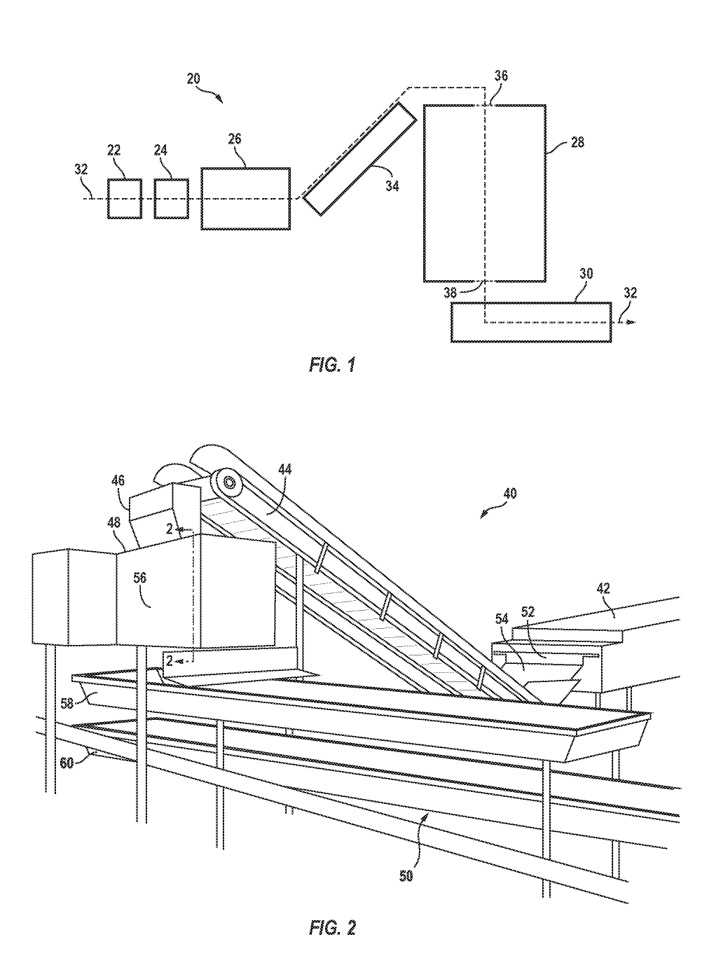

FIG. 1 schematically depicts a system for breaking fruit, generally indicated at 20. System 20 may include an infusing device 22, a dehydrating device 24, a freezer device 26, a mechanical breaking device 28, and a sorting device 30.

As shown in FIG. 1, a processing path 32 may serially pass fruit through infusing device 22, dehydrating device 24, freezing device 26, mechanical breaking device 28, and sorting device 30. However, system 20 may be configured to combine devices, change the order of the devices, omit some devices, and/or change the order that the fruit passes through the devices, such as combining infusing device 22 and dehydrating device 24 and/or placing dehydrating device 24 before infusing device 22 in processing path 32. Processing path 32 may include any suitable number and/or configuration of conveyor belts, rollers, guides, and the like for transporting fruit along processing path 32.

Infusing device 22 may include any suitable device or apparatus configured to infuse fruit with a sweetener. For example, infusing device 22 may include a sugar bath within which either dried or undried fruit is soaked until the fruit is infused with sugar to a desired percentage. In some embodiments, the fruit may absorb moisture during the infusion process. In some embodiments, such as in the case of undried cranberries, the fruit may become dehydrated during infusion due to osmosis of the water in the fruit towards the more concentrated liquid outside the outer skin of the fruit.

The degree of sugar infusion provided by infusing device 22 may depend on the particular application of the system or type of fruit being infused, with typical amounts of sugar infusion falling in the range of 25%-50% infusion by weight. Fruit to be infused may be placed in the infusing device and then removed some time later in a discontinuous or asynchronous process, or fruit may be conveyed through infusing device 22 in a continuous manner, for example by a conveyor belt or any other similar mechanism. Furthermore, infusing device 22 may be configured to infuse fruit with sweeteners other than sugar, such as low-calorie sweeteners, sugar substitutes of any kind, or flavored syrups of various types.

Dehydrating device 24 may include any suitable device or apparatus configured to dehydrate fruit to a desired degree, typically in the case of sugar-infused fruit, to a moisture content of 8%-18%. Dehydrating device 24 may include, for example, a tray dryer, belt dryer, bin dryer, and/or kiln, among others. As in the case of infusing device 22, fruit to be dried may be placed in dehydrating device 24 and removed later in a discontinuous or asynchronous process, or the fruit may be conveyed through the dehydrator in a continuous manner. If conveyed continuously, the conveyance speed may be adjusted to provide the desired degree of dehydration in light of factors such as the type of fruit being processed, sugar content of the fruit, the desired size range of broken fruit pieces, and/or other relevant factors.

Freezing device 26 may include any suitable device or apparatus configured to freeze and/or cryogenically freeze fruit. For example, freezing device 26 may include an immersion bath of liquid nitrogen, an example of which is described in U.S. Patent Application Publication No. 2008/0166468, a cold gas tunnel, an example of which is described in U.S. Patent Application Publication No. 2011/0185761, or the like.

Frozen fruit may be conveyed from freezing device 26 along processing path 32 into mechanical breaking device 28 by any suitable means, for example by a conveyor 34. Conveyor 34 may be a belt conveyor, and/or may be inclined to convey the frozen fruit to a point above mechanical breaking device 28.

Mechanical breaking device 28 may include any suitable apparatus for mechanically breaking fruit, and may include an entry 36 through which frozen fruit may be received in the device, and an exit 38 through which pieces of broken fruit may leave the device. For example, breaking device 28 may include a single or multi-stage roller mill. Mechanical components of breaking device 18 may be cryogenically cooled, such that the frozen fruit is not thawed or otherwise increased in temperature through contact with the mechanical parts or by heat produced by the mechanical breaking of the frozen fruit. Cryogenically cooling some or all of the mechanical parts of mechanical breaking device 28 may allow the frozen fruit to be broken into smaller sizes and may also prevent build-up of fruit on components of mechanical breaking device 18.

Mechanical breaking device 28 may be configured to break the frozen fruit, or a portion thereof, into pieces of a desired size, such as in a range of about ⅛″ to about ⅜.″ In some embodiments, frozen fruit may be broken into pieces in the range of about 1/16″ to about ⅜″. In some applications, reducing calories in a snack food, such as a cookie, may be achieved by dimensioning the cookie to reduce the overall material in the cookie, such as by making the cookie thinner. In a thin cookie application, dried and/or sweetened pieces of fruit of a relatively small size, such as 1/16″ or even smaller, may be desired.

In other applications, smaller, particle-sized fruit pieces may be desirable because they may be dispersed or distributed more evenly throughout the volume of an edible good, providing enhanced flavor characteristics for a given amount of fruit as compared with larger pieces. This allows better flavoring at a reduced cost, because less fruit may be utilized but distributed more uniformly throughout the product. Furthermore, fruit flavoring is desired in many food products without any chunks or granules of visible fruit. The present teachings may be particularly suited to producing small particles of fruit that may be used as flavorings in food products. For example, according to the present teachings, fruit particles may be produced having sizes that range from about 100 micrometers to about 850 micrometers.

The above identified size ranges are merely exemplary. Mechanical breaking device 28 may be configured to break the frozen fruit into any desirable size range. Furthermore, the frozen fruit broken by mechanical breaking device 28 may not all be broken into the desired range. Pieces not broken into the desired range may be re-broken in mechanical device 28, re-broken by another device, or may be used for other applications.

Previously, roller mills were thought to be unsuitable for breaking frozen fruit into small pieces, such as granules or particles suitable for use as flavoring elements in other food products. However, applicants discovered that by cryogenically cooling some of the components of a roller mill (e.g. the rollers), a roller mill, preferably a multistage roller mill, may be used to mechanically break frozen fruit into small and granulesized pieces without producing unacceptable heating effects to the fruit or an abundance of fruit build-up on the rollers.

System 20 may include sorting device 30. Sorting device 30 may include any suitable device or apparatus configured to receive the broken pieces of fruit from breaking device 28 and to sort out any unacceptably-sized pieces for further processing. Sorting device 30 may include, for example, a series of reciprocating or vibrating screens and receptacles (not shown) for sorting the fruit according to size, as described in U.S. Patent Application Publication No. 2008/0166468.

FIG. 2 is a perspective view of an embodiment of a portion of a fruit breaking system, generally indicated at 40, which is generally similar to system 20 described above. System 40 may include an infusing device (not shown), a dehydrating device (not shown), a cold gas tunnel 42, an inclined conveyor 44, a feeder 46, a roller mill 48, and a sorting device 50.

Fruit may be advanced along a processing path in system 40, in similar fashion as along the processing path in system 20. Similarly, fruit may be infused in the infusing device and/or dried in the dehydrating device in any order and/or combination. The fruit may then be advanced into cold gas tunnel 42, a portion of which is shown in FIG. 2, where the fruit may be cryogenically frozen, for example, to a temperature of 88 to 127 degrees Kelvin (about −300 to −230 degrees Fahrenheit). Frozen fruit may exit cold gas tunnel 42 through an exit 52 and slide down a slide 54. Frozen fruit may then be conveyed along inclined conveyor 44 and deposited into feeder 46. Feeder 46 may direct the frozen fruit into roller mill 48 through an entry opening (not shown) into roller mill 48.

Roller mill 48 may have an outer housing 56, as shown in FIG. 2. Some or all of the rollers in roller mill 48 may be cryogenically cooled and may mechanically break the frozen fruit into pieces. Pieces of frozen fruit may then fall or exit through an exit opening (not shown) in roller mill 48, and may be deposited onto sorting device 50.

Sorting device 50 may include a first screen 58 and a second screen 60, both of which may be substantially planar, with first screen 58 spaced above and substantially parallel to second screen 60. Pieces of frozen fruit that fall or exit through the exit opening in roller mill 48 may be deposited on first screen 58.

First screen 58 may be a sizing screen configured to separate pieces having sizes greater than a predetermined size from pieces having sizes less than that size, for instance by having appropriately sized apertures through which only certain pieces may pass. To facilitate this separation, first screen 58 may be configured to vibrate or shake sufficiently to cause smaller pieces to pass through its apertures, and/or may be tilted at a slight downward angle.

In some embodiments, first screen 58 may be configured to vibrate sufficiently vigorously that the vibration of the screen causes frozen fruit disposed on the screen to break into pieces, in which case the vibrating screen may perform some or all of the functions of the breaking device. Broken pieces of fruit having sizes smaller than a desired maximum may fall through apertures in first screen 58 and onto second screen 60, which may convey these pieces into a receptacle (not shown) for collection. First screen 58 may be tilted slightly, and in some embodiments may be configured to facilitate motion of fruit pieces into the receptacle, for example by vibrating. First screen 58 may take the form of a conveyor belt, or any other suitable mechanism, for transporting fruit pieces to a collection point. On the other hand, fruit pieces that are too large to pass through first screen 58 may be collected in another receptacle (not shown), and then re-broken using one or both of roller mill 48 or first screen 58. Overly large pieces may be moved back to roller mill 48 or first screen 58 either by hand, or through the use of an automated system (not shown). Alternatively, if it has been determined that the pieces are substantially correctly sized, the broken pieces may exit roller mill 48 directly into a collection receptacle (not shown) with no additional sorting.

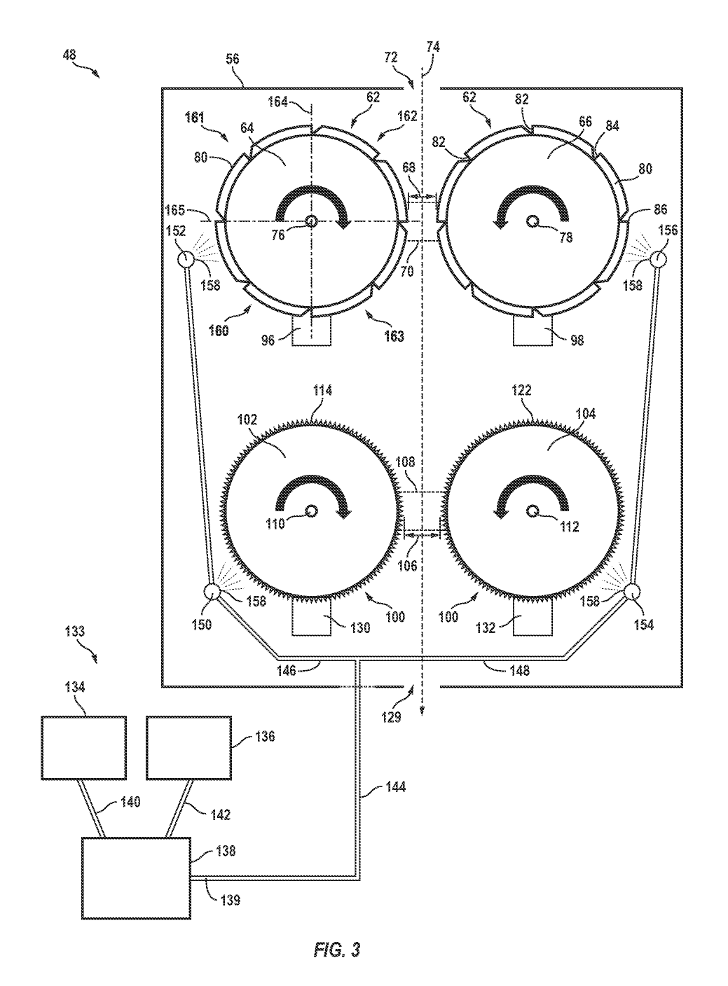

FIG. 3 is a schematically depicts a sectional view of roller mill 48 taken along the line 2-2 in FIG. 2. Roller mill 48 may be a multi-stage roller mill, with multiple, sequential pairs of rollers. For example, roller mill 48 may be two-stage roller mill having two pairs of rollers, as shown in FIG. 3. Other types of roller mills, including single-stage and multi-stage roller mills, also may be suitable for use in conjunction with the present teachings.

Roller mill 48 may include a first roller pair 62. First roller pair 62 may include a first roller 64 spaced from a second roller 66 by a separation distance 68, which may form a breaking region 70 in the area between first roller 64 and second roller 66. Breaking region 70 may generally include a space or volume between rollers 64 and 66, as indicated in FIG. 3.

Sweetened, dried, and/or frozen fruit may enter roller mill 48 through an entry opening 72, and may be guided along processing path 74 into breaking region 70 by way of gravity or any other suitable means, such as feeder 46 of FIG. 2.

First and second rollers 64 and 66 may rotate in opposite directions and may rotate toward each other. As schematically depicted in FIG. 3, first roller 64 may rotate clockwise about a longitudinal axis 76, and second roller 66 may rotate counter-clockwise about a longitudinal axis 78. First and second rollers 64 and 66 may rotate at different speeds. For example, first roller 64 may rotate at a first speed, and second roller 66 may rotate at a second speed substantially different than the first speed. For instance, the second speed may be substantially faster than the first speed. Rotating first and second rollers at different speeds may exert a shearing force on fruit entering or in breaking region 70 in addition to the impact, compression, and/or other fracturing forces caused by passing the frozen fruit through the rollers.

Separation distance 68 may be adjusted (i.e., increased or decreased) to provide an adjustable or controllable crushing force on frozen fruit between first and second rollers 64 and 66 in breaking region 70 as first and second rollers 64 and 66 rotate toward each other. Adjustment of separation distance 68 may cause a corresponding adjustment in the expected size of fruit pieces exiting the rollers.

First and second rollers 64 and 66 may each include a plurality of ridges 80 extending around the circumference of the respective roller. Ridges 80 may be substantially orthogonal to the longitudinal axis of the respective roller. Ridges 80 may be made from a continuous ridge threaded around the circumference of the roller, similar to threads on a screw. Some or all of ridges 80 may each include a plurality of teeth 82. Each tooth of plurality of teeth 82 may include a face surface 84 having a sharp point 86. Each point 86 may be oriented toward the opposite roller of first roller pair 62 as the point approaches breaking region 70.

Scrapers, schematically depicted at 96 and 98, may be configured to scrape or clean first and second rollers 64 and 66, respectively, to remove residue or pieces of fruit deposited on or stuck to the rollers. Scrapers 96 and 98 may each include a thin flexible member (not shown) extending along the respective lengths of first and second rollers 64 and 66. The thin flexible members may be made of a resilient plastic or rubber material, and may be shaped to compliment ridges 80 and/or teeth 82. The thin flexible members may be substantially radially oriented towards respective first and second rollers 64 and 66 and may each respectively be configured to contact an outer surface of the rollers as the rollers rotate about respective longitudinal axes 76 and 78. Scrapers 96 and 98 may be configured such that rotation of the rollers causes a portion of the thin flexible member contacting the outer surface of the roller to be tangentially displaced along the outer surface of the roller. Alternatively, scrapers 96 and 98 may each include a thin rigid member. The thin rigid member may be made of a rigid plastic, composite, or metallic material, and may be configured and shaped to compliment ridges 80 and to contact the outer surface of the roller. A portion of the thin rigid member contacting or in proximity to the outer surface of the roller may be angled against a direction of rotation of the roller, such that the thin rigid member may create a shearing force between a portion of material which may be deposited on the outer surface of the roller.

Roller mill 48 may include a second roller pair 100. Second roller pair 100 may include a third roller 102 spaced from a fourth roller 104 by a separation distance 106, which may form a breaking region 108 generally between third roller 102 and fourth roller 104. Breaking region 108 may include a space or volume formed between third and fourth rollers 102 and 104, as depicted in FIG. 3.

Sweetened, dried, and/or frozen fruit may be guided along processing path 74 from breaking region 70 into breaking region 108 by way of gravity or any other suitable means, such as one or more guides, slides, conveyors, or the like.

Third and fourth rollers 102 and 104 may rotate in opposite directions and may rotate toward each other. As schematically depicted in FIG. 3, third roller 102 may rotate clockwise about a longitudinal axis 110, and fourth roller 104 may rotate counter-clockwise about a longitudinal axis 112. Third and fourth rollers 102 and 104 may rotate at different speeds. For example, third roller 102 may rotate at a third speed, and fourth roller 104 may rotate at a fourth speed substantially different than the third speed. For instance, the fourth speed may be substantially faster than the third speed. Rotating third and fourth rollers 102 and 104 at different speeds may exert a shearing force on fruit entering or in breaking region 108 in addition to the impact, compression, and/or other fracturing forces caused by passing the frozen fruit through the rollers.

Separation distance 106 may be adjusted (i.e., increased or decreased) to provide an oppositional or crushing force between third and fourth rollers 102 and 104 in breaking region 108 as third and fourth rollers 102 and 104 rotate toward each other. Generally, separation distance 68 between the first roller pair may be greater than separation distance 106 between the second roller pair, as shown in FIG. 3. This relative difference may allow for first and second rollers 64 and 66 to break fruit into pieces and third and fourth rollers 102 and 104 to break those pieces into smaller pieces. However, separation distance 68 and separation distance 106 may be configured in any way desired. For example, separation distance 68 may be less than or equal to separation distance 106.

Third roller 102 may include a plurality of longitudinal ridges 114 on an outer surface, extending along a length of third roller 102. Ridges 114 may be substantially parallel to longitudinal axis 110. In some embodiments, ridges 114 may be skewed to some extent. In some embodiments, each of ridges 114 may have a peaked, pointed, rounded, blunt, squared, multi-membered, or any other suitable profile. In some embodiments, different ridges have differently shaped profiles. Each of ridges 114 may be thinner in cross section than each of ridges 80. Accordingly, the first roller pair may be described as being more “coarse” than the second roller pair.

Fourth roller 104 may include a similar plurality of longitudinal ridges 122 extending along a length of fourth roller 104. Ridges 122 may be substantially parallel to longitudinal axis 112.

Ridges 80 of first roller 64 may intermesh ridges 80 of second roller 66 in breaking region 70; and ridges 114 of third roller 102 may intermesh with ridges 122 of fourth roller 104 in breaking region 108.

Sweetened, dried, and/or frozen fruit may be guided along processing path 74 from breaking region 108, may exit roller mill 48 through an exit opening 129, and may be guided along processing path 74 into sorting device 50 (see FIG. 2) by way of gravity or any other suitable means.

Scrapers 130 and 132 may be configured to scrape or clean third and fourth rollers 102 and 104, respectively, to remove residue or pieces of fruit deposited on or stuck to the rollers. Scrapers 130 and 132 may each include a thin flexible member (not shown) extending along the respective lengths of third and fourth rollers 102 and 104. The thin flexible members may be made of a resilient plastic or rubber material, and may be shaped to compliment ridges 114 and 122, respectively. The thin flexible members may be substantially radially oriented towards respective third and fourth rollers 102 and 104 and may each respectively be configured to contact an outer surface of each roller as the rollers rotates about respective longitudinal axes 110 and 112. Scrapers 130 and 132 may be configured such that rotation of the rollers causes a portion of the thin flexible member contacting the outer surface of the roller to be tangentially displaced along the outer surface of the roller. Alternatively, scrapers 130 and 132 may each include a thin rigid member. The thin rigid member may be made of a rigid plastic, composite, or metallic material, and may be configured and shaped to compliment ridges 114 and 122, respectively, and to contact the outer surface of the roller. A portion of the thin rigid member contacting or in proximity to the outer surface of the roller may be angled against a direction of rotation of the roller, such that the thin rigid member may create a shearing force between a portion of material which may be deposited on the outer surface of the roller.

One or more rollers in first roller pair 62 and/or second roller pair 100 may be cryogenically cooled. Accordingly, system 40 may include a cooling apparatus 133 having a liquid nitrogen (LIN) source 134, a gaseous nitrogen (GAN) source 136, and a LIN/GAN mixing region 138, as depicted schematically in FIG. 3. Liquid nitrogen and gaseous nitrogen may be provided from any known or standard source, such as one or more holding tanks or containers, and may be under pressure. LIN from LIN source 134 and GAN from GAN source 136 may pass through respective suitable passages such as pipes 140 and 142 toward LIN/GAN mixing region 138. In some embodiments, tubing or hoses may be used in addition to or in place of pipes 140 and/or 142. LIN and GAN in LIN/GAN mixing region 138 may mix to form a nitrogen vapor 139. The nitrogen vapor may proceed through pipe 144 into outer housing 56 of roller mill 48. Pipe 144 may feed into pipes 146 and 148, which may in turn deliver the nitrogen vapor to cooling manifolds 150, 152, 154, and 156 disposed inside outer housing 56.

Each cooling manifold may include a plurality of orifices 158 through which the nitrogen vapor may be applied to an external surface of a roller. For example, cooling manifold 150 may be configured to apply the nitrogen vapor to an external surface of third roller 102; cooling manifold 152 may be configured to apply the nitrogen vapor to an external surface of first roller 64; cooling manifold 154 may be configured to apply the nitrogen vapor to an external surface of fourth roller 104; and cooling manifold 156 may be configured to apply the nitrogen vapor to an external surface of second roller 66. The cooling manifolds may be configured to apply the nitrogen vapor or other cryogen only to the rollers. In other words, the cooling manifolds may be located and/or oriented such that the cryogen is directed to impinge upon the rollers, but to avoid contacting, for example, the fruit.

First roller pair 62 and/or second roller pair 100 may be cryogenically cooled by rotating the rollers while the nitrogen vapor is applied to an exterior surface of each of the rollers through the plurality of orifices 158. An external surface of a roller, such as first roller 64, may be exposed to a cryogen, such as the nitrogen vapor or any other suitable cryogen as previously described, within one-half of a rotation of a breaking region, such as breaking region 70. Cooling the surface of the roller within half a rotation may facilitate improved cooling and/or reduced heating of the roller by contacting the roller shortly after the roller is frictionally heated by breaking the fruit in the breaking region.

Each roller may rotate about a longitudinal axis. Four quadrants may be defined in space, the quadrants being formed by two imaginary planes intersecting orthogonally at the longitudinal axis. The nitrogen vapor, or any other suitable cryogen, may be applied to the exterior surface of one or more of the rollers in an outer lower quadrant, where outer may be defined as generally away from an opposite roller of the roller pair and lower may be defined as generally away from where the frozen, dried, and/or sweetened fruit enters when passing between the roller pair.

For example, first roller 64 may rotate about longitudinal axis 76 which may define four quadrants 160, 161, 162, and 163 in space formed by two imaginary planes 164 and 165 intersecting orthogonally at longitudinal axis 76, and the nitrogen vapor may be applied to the exterior surface of first roller 64 in outer lower quadrant 160. The nitrogen vapor may be applied in a similar fashion to the exterior surfaces of second roller 66, third roller 102, and fourth roller 104, as indicated in FIG. 3.

The external surface of any given roller may be continuously exposed to a cryogen, and may be continuously exposed as the roller rotates. Alternatively, the external surface of any given roller may be intermittently exposed to the cryogen, and may be intermittently exposed as the roller rotates.

Exposing one or more of the rollers to a cryogen in a region outside of the respective breaking region may allow for one or more of the rollers to be more efficiently cryogenically cooled. For instance, exposing the roller to a cryogen outside of the breaking region may allow for more contact between the cryogen and the roller for a greater period of time than if the cryogen was applied in or proximate the breaking region. Applying the cryogen to the roller in or proximate the breaking region may cause the cryogen to cover a portion of the fruit, which may allow less cryogen to be in contact with the roller for a given period of time.

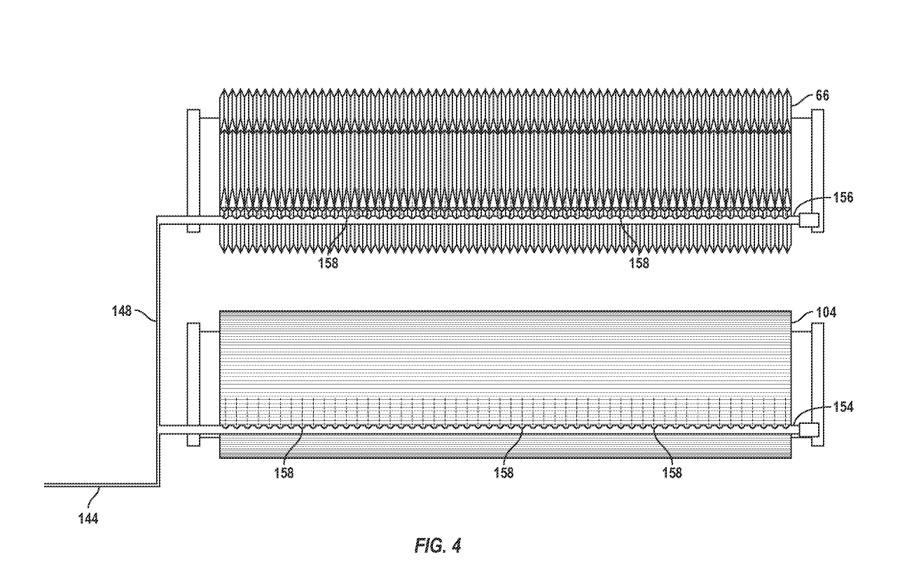

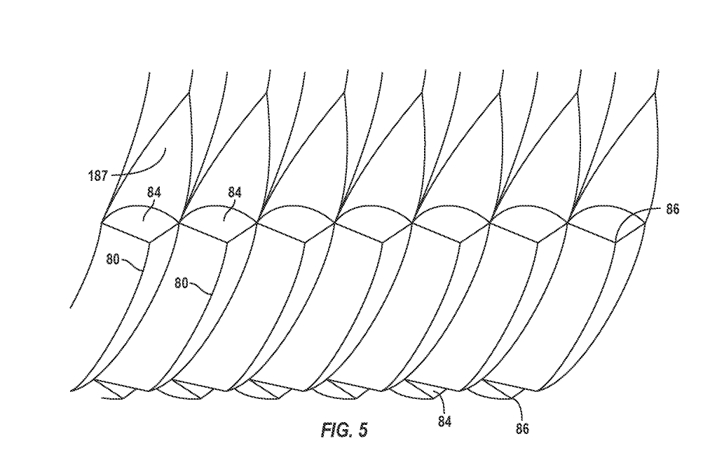

FIG. 4 is a schematic diagram showing a lateral elevation view of second and fourth rollers 66 and 104 and cooling manifolds 154 and 156. Pipe 144 may feed the nitrogen vapor to pipe 148, and pipe 148 may feed the nitrogen gas to cooling manifolds 154 and 156, which may each extend along the respective lengths of rollers 104 and 66. Plurality of orifices 158 may be arranged in cooling manifolds 154 and 156 along the respective lengths of fourth and second rollers 104 and 66 to direct a cryogen, such as the nitrogen vapor, toward a majority of the exterior surfaces of those rollers that come into contact with fruit in either of breaking regions 70 and/or 108 (see FIG. 3). A similar arrangement exists for rollers 64 and 102, and manifolds 150 and 152.

FIG. 5 is a detailed isometric view of teeth disposed along ridges of an illustrative roller, such as teeth 82, which may be disposed in ridges 80 on first and second rollers 64 and 66 (see FIG. 3). Each face surface 84 may be a substantially planar surface, which may extend substantially radially from the roller. Each tooth may include a second substantially planar surface 187, which may extend substantially tangentially from the roller. Face surface 84 together with ridge 80 may form each tooth having a sharp point 86.

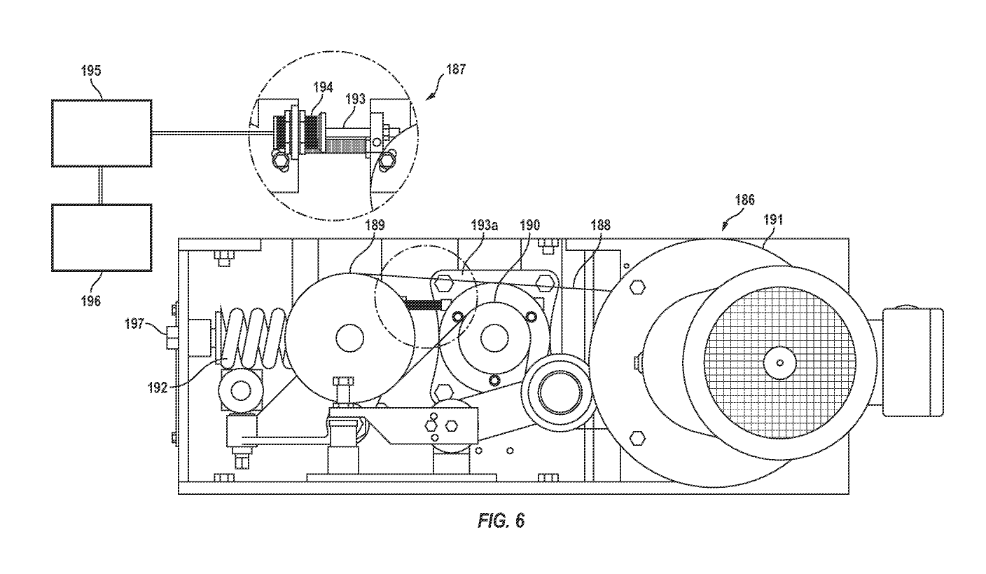

FIG. 6 is an end elevation view of a portion of a roller mill such as roller mill 48 showing an embodiment of a drive mechanism, generally indicated at 186, and a roller separation mechanism, generally indicated at 187, for an illustrative pair of rollers such as pairs of rollers 62 and/or 100.

Drive mechanism 186 may include any suitable apparatus configured to drive two rollers of a roller pair at constant but different speeds. For example, drive mechanism 186 may include a belt 188, a first pulley 189 connected to a first roller of a roller pair (not shown), a second pulley 190 connected to a second roller of the roller pair (not shown), and a drive motor 191. Drive motor 191 may include any device configured to act as a prime mover to provide rotational motive force to drive mechanism 186. In some embodiments, drive motor 191 may include a controllable motor such as an electric servomotor. In this example, drive motor 191 is an electric motor. Drive motor 191 may drive first and second pulleys 189 and 190 via belt 188, and first and second pulleys 189 and 190 may be configured such that the first roller of the roller pair may be driven at a different speed than the second roller of the roller pair. For example, first pulley 189 may have a larger circumference than second pulley 190, which may provide the first roller with a slower rotation than the second roller.

Roller separation mechanism 187 may include any suitable apparatus configured to adjust a separation distance between two rollers. For example, roller separation mechanism 187 may include a biasing mechanism 192, a gap stop 193, a gap adjustment mechanism 194, a controller 195, and an interface 196. Biasing mechanism 192 may include any apparatus configured to bias the first roller of the roller pair toward the second roller of the roller pair, and any apparatus configured to adjust the bias provided by biasing mechanism 192. As shown, biasing mechanism 192 may include a biasing spring. Bias provided by biasing mechanism 192 on the first roller toward the second roller may be adjusted by adjustment mechanism 197, which may include any mechanism configured to adjust the bias provided by biasing mechanism 192. For example, adjustment mechanism 197 may include a screw configured to alter the bias provided by biasing mechanism 192, and actuation of the screw may increase or decrease the force provided by biasing mechanism 192 on the first roller of the roller pair.

The first roller may be prevented from contacting the second roller by gap stop 193 and gap adjustment mechanism 194. Gap stop 193 may include any apparatus configured to provide a force counter to biasing mechanism 192, such that the first roller may not contact the second roller, which may provide a separation distance between the two rollers. Gap adjustment mechanism 194 may include any mechanism configured to adjust the separation distance between the two rollers. For example, gap stop 193 may be rigidly connected to a platform 193a for the second roller of the roller pair, gap adjustment mechanism 194 may be rigidly connected to a platform (not shown) for the first roller of the roller pair, and each roller may rotate relative to the platform associated with that roller about a longitudinal axis that does not translate relative to that platform. Gap adjustment mechanism 194 may be configured to press against gap stop 193 to prevent biasing spring 192 from biasing the first roller into contact with the second roller. Gap adjustment mechanism 194 may include an electric servomotor, which when actuated may increase or decrease the roller separation distance between the first and second rollers of the roller pair. The electric servomotor may be connected to controller 195 which may control the electric servomotor, and controller 195 may be connected interface 196 which may control controller 195. Interface 196 may allow a user to alter or otherwise adjust the roller separation distance between the first and second rollers of the roller pair via controller 195 and the electric servomotor.

First roller pair 62, roller separation distance 68, second roller pair 100, and/or roller separation distance 108 may be adjusted and/or altered with a drive mechanism similar to drive mechanism 186 and/or a roller separation mechanism similar to roller separation 187. Sizes of the pieces of fruit exiting roller mill 48 may be monitored, and the roller separation distances of either or both of the roller pairs may be altered in order to satisfy a desired parameter, such as a particular size range of the pieces of fruit. For example, if the fruit pieces exiting roller mill 48 are undesirably large, then the roller separation mechanism may be adjusted to reduce the roller separation distance between either or both of the roller pairs 62 and 100.

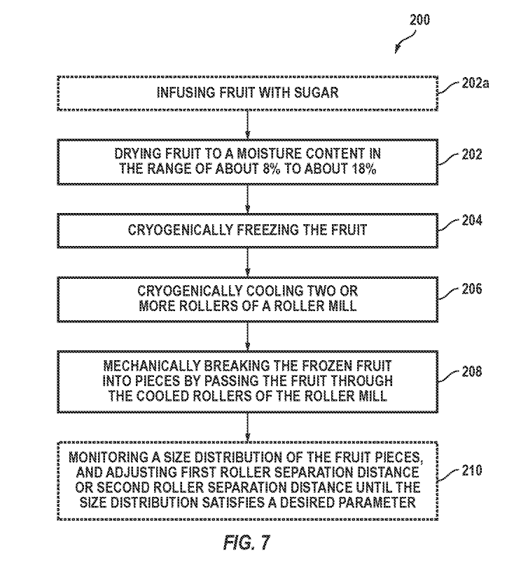

FIG. 7 is a flowchart depicting an illustrative method, generally indicated at 200, for mechanically sizing fruit, possibly in conjunction with an apparatus such as one of those described above.

Step 202 of method 200 may include drying fruit to a moisture content in the range of about 8% to about 18%. Drying the fruit may include infusing the fruit with sugar or some other sweetener.

Step 202A of method 200 may include infusing the fruit with sugar prior to drying the fruit. This step may be performed, for example, if the drying step 202 does not include infusing the fruit with sugar, or if additional infusion of sugar is desired beyond what is achieved in the drying step.

Step 204 of method 200 may include cryogenically freezing the fruit. For example, cryogenically freezing the fruit may include exposing the fruit to a cryogen, such as liquid nitrogen, liquid oxygen, liquid carbon dioxide, liquid helium, solid carbon dioxide, gaseous nitrogen, and/or a mixture of liquid and gaseous nitrogen, among others. In some cases, cryogenically freezing the fruit may involve conveying the fruit through a cold gas tunnel, as described above, while in other cases, it may involve exposing the fruit to the cryogen through immersion, spraying, blowing, or by any other suitable means. The fruit may be cryogenically frozen to any desired temperature, and in some cases (depending on the particular type of fruit, the moisture content, and/or the degree of sugar infusion) colder temperatures may be correlated to more brittle fruit and, ultimately, to smaller pieces of broken fruit. A suitable temperature range for most fruits is from 88-127 degrees Kelvin (about −300 to −230 degrees Fahrenheit).

Step 206 of method 200 may include cryogenically cooling two or more rollers of a roller mill. For example, cryogenically cooling the two or more rollers may include applying a mixture of liquid nitrogen and gaseous nitrogen to an external surface of each of the two or more rollers.

Step 208 of method 200 may include breaking the frozen fruit into pieces. Breaking the fruit may include passing the frozen fruit between a first pair of rollers, and may be followed by passing the frozen fruit between a second pair of rollers. The first pair of rollers may have a first roller separation distance and the second pair of rollers may have a second roller separation distance. The first roller separation distance may be greater than the second roller separation distance.

Step 210 of method 200 may include monitoring a size distribution of the fruit pieces. For example, fruit piece sizes may be monitored, and the first roller separation distance or the second roller separation distance may be adjusted until the size distribution satisfies a desired parameter.

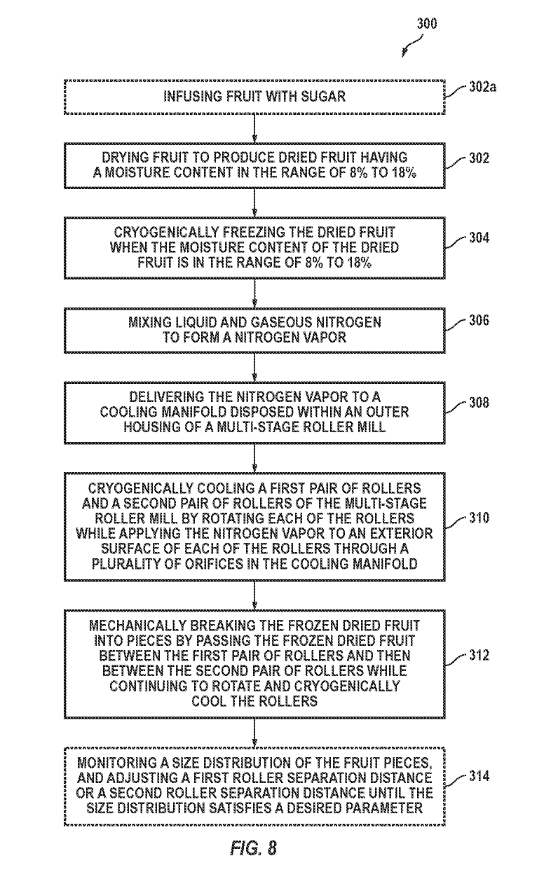

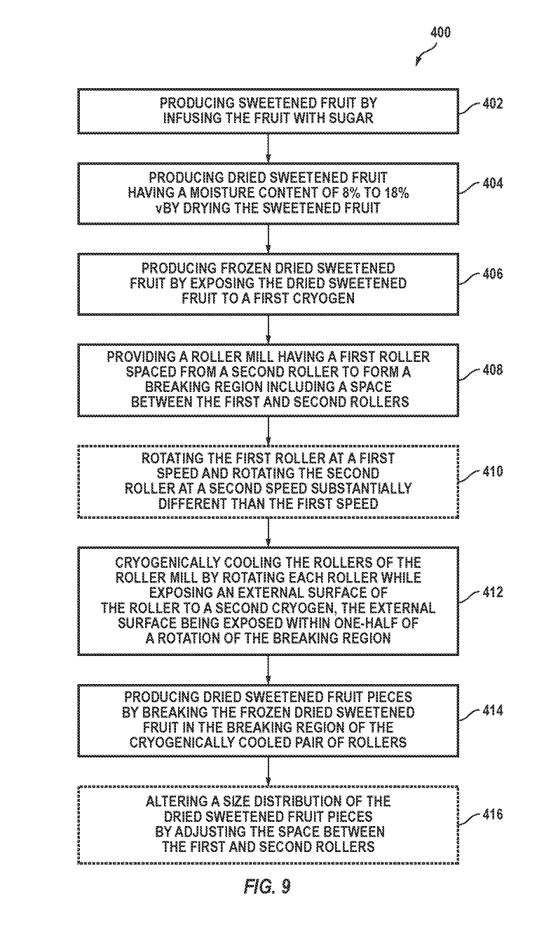

FIG. 8 is a flowchart depicting an illustrative method, generally indicated at 300, for transforming whole fruit into dried fruit pieces, possibly in conjunction with an apparatus such as one of those described above.

Step 302 of method 300 may include drying the fruit to produce dried fruit having a moisture content in the range of 8%-18%. Drying the fruit may include infusing the fruit with sugar.

Step 302A of method 300 may include infusing the fruit with sugar prior to drying the fruit. As in method 200, this step may be performed to replace or supplement sweetener infusion that occurs during the drying step.

Step 304 of method 300 may include cryogenically freezing the dried fruit when the moisture content of the dried fruit is in the range of 8%-18%. For example, cryogenically freezing the dried fruit may include exposing the dried fruit to a cryogen, such as liquid nitrogen, liquid oxygen, liquid carbon dioxide, liquid helium, solid carbon dioxide, gaseous nitrogen, or a mixture of liquid and gaseous nitrogen, among others. In some embodiments, cryogenically freezing the dried fruit may involve conveying the dried fruit through a cold gas tunnel, as described above, while in other cases, it may involve exposing the dried fruit to the cryogen through immersion, spraying, blowing, or by any other suitable means. The dried fruit may be cryogenically frozen to any desired temperature, and in some cases (depending on the particular type of fruit, the moisture content, and/or the degree of sugar infusion) colder temperatures may be correlated to more brittle dried fruit and, ultimately, to smaller pieces of broken fruit. A suitable temperature range from most fruits is from 88-127 degrees Kelvin (about −300 to −230 degrees Fahrenheit).

Step 306 of method 300 may include mixing liquid nitrogen and gaseous nitrogen to form a nitrogen vapor.

Step 308 of method 300 may include delivering the nitrogen vapor to a cooling manifold disposed within an outer housing of a multi-stage roller mill.

Step 310 of method 300 may include cryogenically cooling a first pair of rollers and a second pair of rollers of the multi-stage roller mill by rotating each of the rollers while applying the nitrogen vapor to an external surface of each of the rollers through a plurality of orifices in the cooling manifold. Each roller of the first pair of rollers may rotate about a longitudinal axis and may define four quadrants in space formed by two imaginary planes intersecting orthogonally at the longitudinal axis. Applying the nitrogen vapor to the exterior surface of each of the rollers may include applying the nitrogen vapor to an outer lower quadrant, where outer may be defined as generally away from an opposite roller of the pair of rollers and lower may be defined as generally away from where the frozen fruit may enter when passing between the pair of rollers. Nitrogen vapor may be similarly applied to the second pair of rollers.

Step 312 of method 300 may include mechanically breaking the frozen dried fruit into pieces by passing the frozen dried fruit between the first pair of rollers and then between the second pair of rollers while continuing to rotate and cryogenically cool the rollers. Rotating each of the rollers may include rotating one of the rollers of each pair at a different speed than the other of the rollers of the same pair. Each of the rollers of the first pair of rollers may include a plurality of ridges extending around a circumference of the roller, and each of the rollers of the second pair of rollers may include a plurality of ridges extending along a length of the roller. The first pair of rollers may have a first roller separation distance and the second pair of rollers may have a second roller separation distance. The first roller separation distance may be greater than the second roller separation distance.

Step 314 of method 300 may include monitoring a size distribution of the fruit pieces. For example, fruit piece sizes may be monitored, and the first roller separation distance or the second roller separation distance may be adjusted until the size distribution satisfies a desired parameter.

FIG. 9 is a flowchart depicting an illustrative method, generally indicated at 400, for transforming fruit into dried sweetened fruit pieces, possibly in conjunction with an apparatus described in the present teachings.

Step 402 of method 400 may include producing sweetened fruit by infusing the fruit with sugar.

Step 404 of method 400 may include producing dried sweetened fruit having a moisture content of 8%-18% by drying the sweetened fruit.

Step 406 of method 400 may include producing frozen dried sweetened fruit. For example, producing frozen dried sweetened fruit may include exposing the dried sweetened fruit to a first cryogen. In some embodiments, freezing the dried fruit may involve conveying the dried sweetened fruit through a cold gas tunnel, as described above, while in other cases, it may involve exposing the dried sweetened fruit to the first cryogen through immersion, spraying, blowing, or by any other suitable means. The dried sweetened fruit may be frozen to any desired temperature, and in some cases (depending on the particular type of fruit, the moisture content, and/or the degree of sugar infusion) colder temperatures may be correlated to more brittle dried sweetened fruit and, ultimately, to smaller fruit pieces. A suitable temperature range from most fruits is from 88-127 degrees Kelvin (about −300 to −230 degrees Fahrenheit).

Step 408 of method 400 may include providing a roller mill having a first roller spaced from a second roller to form a breaking region. The breaking region may include a space between the first and second rollers.

Step 410 of method 400 may include rotating the first roller at a first speed and rotating the second roller at a second speed substantially different than the first speed.

Step 412 of method 400 may include cryogenically cooling the rollers of the roller mill. For example, cryogenically cooling the rollers of the roller mill may include rotating each roller while exposing an external surface of the roller to a second cryogen. In some embodiments, the first and second cryogens may be the same or similar cryogens, such as liquid nitrogen and gaseous nitrogen mixed together to form a nitrogen vapor.

Step 414 of method 400 may include producing dried sweetened fruit pieces. For example, producing dried sweetened fruit pieces may include breaking the frozen dried sweetened fruit in the breaking region of the cryogenically cooled pair of rollers.

Step 416 of method 400 may include altering a size distribution of the dried sweetened fruit pieces. For example, altering the size distribution of the sweetened fruit pieces may include adjusting the space between the first and second rollers.

Based on the above description and the associated drawings, the following examples further describe various embodiments of apparatuses and methods of the disclosure.

A first illustrative method for mechanically sizing fruit may include drying the fruit to a moisture content in the range of about 8% to about 18%, cryogenically freezing the fruit, cryogenically cooling two or more rollers of a roller mill, and mechanically breaking the frozen fruit into pieces by passing the fruit through the cooled rollers of the roller mill.

Cryogenically cooling the two or more rollers may include applying a mixture of liquid nitrogen and gaseous nitrogen to an external surface of each of the two or more rollers.

The first illustrative method may include infusing the fruit with sugar prior to drying the fruit.

Drying the fruit may include infusing the fruit with sugar.

Breaking the frozen fruit into pieces may include passing the frozen fruit between a first pair of rollers. Passing the frozen fruit between a first pair of rollers may be followed by passing the frozen fruit between a second pair of rollers.

The first pair of rollers may have a first roller separation distance and the second rollers may have a second roller separation distance, and the first roller separation distance may be greater than the second roller separation distance.

The first illustrative method may further include monitoring a size distribution of the fruit pieces, and adjusting the first roller separation distance or the second roller separation distance until the size distribution satisfies a desired parameter.

A second illustrative method for transforming whole fruit into dried fruit pieces may include drying the fruit to produce dried fruit having a moisture content in the range of 8% to 18%, cryogenically freezing the dried fruit when the moisture content is in the range of 8% to 18%, mixing liquid and gaseous nitrogen to form a nitrogen vapor, delivering the nitrogen vapor to a cooling manifold disposed within an outer housing of a multi-stage roller mill, cryogenically cooling a first pair of rollers and a second pair of rollers of the multi-stage roller mill by rotating each of the rollers while applying the nitrogen vapor to an exterior surface of each of the rollers through a plurality of orifices in the cooling manifold, and mechanically breaking the frozen dried fruit into pieces by passing the frozen dried fruit between the first pair of rollers and then between the second pair of rollers while continuing to rotate and cryogenically cool the rollers.

Applying the nitrogen vapor to the exterior surface of each of the rollers may include applying the nitrogen vapor to only the rollers.

Each of the rollers of the first pair of rollers may include a plurality of ridges extending around a circumference of the roller. Each of the rollers of the second pair of rollers may include a plurality of ridges extending along a length of the roller.

Rotating each of the rollers may include rotating one of the rollers of each pair at a different speed than the other of the rollers of the same pair.

The second illustrative method may further include infusing the fruit with sugar prior to drying the fruit.

Drying the fruit may include infusing the fruit with sugar.

The first pair of rollers may have a first roller separation distance. The second pair of rollers may have a second roller separation distance. The first roller separation distance may be greater than the second roller separation distance.

The second illustrative method may further include monitoring a size distribution of the fruit pieces, and adjusting the first roller separation distance or the second roller separation distance until the size distribution satisfies a desired parameter.

A third illustrative method for transforming fruit into dried sweetened fruit pieces may include producing sweetened fruit by infusing the fruit with sugar, producing dried sweetened fruit having a moisture content of 8% to 18% by drying the sweetened fruit, producing frozen dried sweetened fruit by exposing the dried sweetened fruit to a first cryogen, providing a roller mill having a first roller spaced from a second roller to form a breaking region including a space between the first and second rollers, cryogenically cooling the rollers of the roller mill by rotating each roller while exposing an external surface of the roller to a second cryogen (the external surface being exposed within one-half of a rotation of the breaking region), and producing dried sweetened fruit pieces by breaking the frozen dried sweetened fruit in the breaking region of the cryogenically cooled pair of rollers.

The third illustrative method may further include altering a size distribution of the dried sweetened fruit pieces by adjusting the space between the first and second rollers.

Producing frozen dried sweetened fruit may include exposing the dried sweetened fruit to the first cryogen until the dried sweetened fruit reaches a temperature of 88 to 127 degrees Kelvin.

Exposing the external surface of the roller to the second cryogen may include continuously exposing the external surface of the roller to a mixture of liquid nitrogen and gaseous nitrogen.

The third illustrative method may further include rotating the first roller at a first speed and rotating the second roller at a second speed substantially different than the first speed.

Exposing the external surface of the roller to the second cryogen may include intermittently exposing the external surface of the roller to the second cryogen.

The disclosure set forth above may encompass multiple distinct inventions with independent utility. The disclosure includes a number of section headings, which were added for convenience, and which are not intended to limit the disclosure in any way (e.g., the headings to not foreclose using information described in one section in place of, and/or in combination with, information described in other sections). Similarly, the disclosure relates information regarding specific embodiments, which are included for illustrative purposes, and which are not to be considered in a limiting sense, because numerous variations are possible. The inventive subject matter of the disclosure includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

What is claimed is:

1. A method for mechanically sizing fruit, the method comprising:
drying the fruit to a moisture content in the range of about 8% to about 18%;
cryogenically freezing the fruit;
cryogenically cooling two or more rollers of a roller mill; and
mechanically breaking the frozen fruit into pieces by passing the fruit through the cooled rollers of the roller mill.

2. The method of claim 1, wherein cryogenically cooling the two or more rollers includes applying a mixture of liquid nitrogen and gaseous nitrogen to an external surface of each of the two or more rollers.

3. The method of claim 1, further comprising infusing the fruit with sugar prior to drying the fruit.

4. The method of claim 1, wherein drying the fruit includes infusing the fruit with sugar.

5. The method of claim 1, wherein breaking the frozen fruit into pieces includes passing the frozen fruit between a first pair of rollers, followed by passing the frozen fruit between a second pair of rollers.

6. The method of claim 5, wherein the first pair of rollers has a first roller separation distance and the second pair of rollers has a second roller separation distance, and the first roller separation distance is greater than the second roller separation distance.

7. The method of claim 6, further including monitoring a size distribution of the fruit pieces, and adjusting the first roller separation distance or the second roller separation distance until the size distribution satisfies a desired parameter.

8. A method for transforming whole fruit into dried fruit pieces, the method comprising:
drying the fruit to produce dried fruit having a moisture content in the range of 8% to 18%;
cryogenically freezing the dried fruit when the moisture content of the dried fruit is in the range of 8% to 18%;
mixing liquid and gaseous nitrogen to form a nitrogen vapor;
delivering the nitrogen vapor to a cooling manifold disposed within an outer housing of a multi-stage roller mill;
cryogenically cooling a first pair of rollers and a second pair of rollers of the multi-stage roller mill by rotating each of the rollers while applying the nitrogen vapor to an exterior surface of each of the rollers through a plurality of orifices in the cooling manifold; and
mechanically breaking the frozen dried fruit into pieces by passing the frozen dried fruit between the first pair of rollers and then between the second pair of rollers while continuing to rotate and cryogenically cool the rollers.

9. The method of claim 8, wherein applying the nitrogen vapor to the exterior surface of each of the rollers includes applying the nitrogen vapor to the rollers without applying the nitrogen vapor to the fruit.

10. The method of claim 8, wherein each of the rollers of the first pair of rollers includes a plurality of ridges extending around a circumference of the roller, and each of the rollers of the second pair of rollers includes a plurality of ridges extending along a length of the roller.

11. The method of claim 8, wherein rotating each of the rollers includes rotating one of the rollers of each pair at a different speed than the other of the rollers of the same pair.

12. The method of claim 8, further comprising infusing the fruit with sugar prior to drying the fruit.

13. The method of claim 8, wherein drying the fruit includes infusing the fruit with sugar.

14. The method of claim 8, wherein the first pair of rollers has a first roller separation distance and the second pair of rollers has a second roller separation distance, and the first roller separation distance is greater than the second roller separation distance.

15. The method of claim 13, further including monitoring a size distribution of the fruit pieces, and adjusting the first roller separation distance or the second roller separation distance until the size distribution satisfies a desired parameter.

16. A method for transforming fruit into dried sweetened fruit pieces, the method comprising:
producing sweetened fruit by infusing the fruit with sugar;
producing dried sweetened fruit having a moisture content of 8% to 18% by drying the sweetened fruit;
producing frozen dried sweetened fruit by exposing the dried sweetened fruit to a first cryogen;
providing a roller mill having a first roller spaced from a second roller to form a breaking region including a space between the first and second rollers;
cryogenically cooling the rollers of the roller mill by rotating each roller while exposing an external surface of the roller to a second cryogen, the external surface being exposed to the second cryogen outside the breaking region but within one-half of a rotation of the breaking region; and
producing dried sweetened fruit pieces by breaking the frozen dried sweetened fruit in the breaking region of the cryogenically cooled pair of rollers.

17. The method of claim 16, further comprising altering a size distribution of the dried sweetened fruit pieces by adjusting the space between the first and second rollers.

18. The method of claim 16, wherein producing frozen dried sweetened fruit includes exposing the dried sweetened fruit to the first cryogen until the dried sweetened fruit reaches a temperature of 88 to 127 degrees Kelvin.

19. The method of claim 16, further comprising rotating the first roller at a first speed and rotating the second roller at a second speed substantially different than the first speed.

20. The method of claim 16, wherein exposing the external surface of the roller to the second cryogen includes intermittently exposing the external surface of the roller to the second cryogen.
